(19) United States
(12) Patent Application Publication
(10) Pub. No.: US 2022/0316511 A1
(43) Pub. Date: Oct. 6, 2022

(54) QUICK RELEASE CONNECTING ASSEMBLY

(71) Applicant: Lonman Auto Accessories Co., Ltd, Dongguan (CN)

(72) Inventor: Shihu LONG, Dongguan (CN)

(73) Assignee: Lonman Auto Accessories Co., Ltd, Dongguan (CN)

(21) Appl. No.: 17/330,454

(22) Filed: May 26, 2021

(30) Foreign Application Priority Data
Mar. 31, 2021 (CN) 202120650283.X

(51) Int. Cl. F16B 9/00

(52) U.S. Cl. CPC F16B 9/056

(57) ABSTRACT

A quick release connecting assembly is provided. The quick release connecting assembly includes a first connector and a second connector, wherein the first connector includes an upper fixed plate, a middle portion of the upper fixed plate is connected to a connecting column, and a clamping slot is formed in a middle portion of the connecting column; and the second connector includes a lower fixed plate, a middle portion of the lower fixed plate is connected to a connecting pipe matched with the connecting column, a side surface of the connecting pipe is connected to a side pipe communicating with the connecting pipe, and a bolt column is arranged in the side pipe. The connecting column of the first connector and the bolt column of the second connector are clamped, such that the quick release connecting assembly is simple in integral structure and convenient to disassemble and assemble.

### CROSS REFERENCE TO THE RELATED APPLICATIONS

This application is based upon and claims priority to Chinese Patent Application No. 202120650283.X filed on Mar. 31, 2021, the entire contents of which are incorporated herein by reference.

### TECHNICAL FIELD

The invention relates to the technical field of connectors, in particular to a quick release connecting assembly.

### BACKGROUND

With increase of number of times of going out for a trip by car, in order to facilitate camping, many people carry vehicle tents. However, when current vehicle tents are fixed to top holders, the bottoms of the vehicle tents are fixed to the top holders by means of connectors such as bolts, and in this way, it is relatively time- and labor-wasting to mount and detach the vehicle tents and is inconvenient to operate.

### SUMMARY

Aiming to overcome defects in the prior art, the invention provides a quick release connecting assembly. The quick release connecting assembly can be assembled and detached quickly, and is convenient to operate.

A quick release connecting assembly includes

a first connector and a second connector, wherein the first connector comprises an upper fixed plate, a middle portion of the upper fixed plate is connected to a connecting column, and a clamping slot is formed in a middle portion of the connecting column;

and the second connector comprises a lower fixed plate, a middle portion of the lower fixed plate is connected to a connecting pipe matched with the connecting column, a side surface of the connecting pipe is connected to a side pipe communicating with the connecting pipe, and a bolt column is arranged in the side pipe.

Further, an inner edgefold is arranged on an outer end portion of the side pipe, a spring for pushing the bolt column inward is arranged in the side pipe, the spring is connected outside the bolt column in a sleeving manner, a side surface of the bolt column is connected to a limiting block, and two ends of the spring lean against the limiting block and the inner edgefold, separately.

Further, a mounting hole is formed in a side surface of the bolt column, and the limiting block is fixed in the mounting hole.

Preferably, an outer end portion of the bolt column is connected to an operating block.

Further, an L-shaped notch matched with the limiting block is arranged on the side surface of the side pipe and the L-shaped notch is inserted onto the outer end portion of the limiting block.

Further, a lower end of the connecting column is cone-shaped.

Further, an upper end of the connecting pipe is connected to a carrying ring.

The invention has the beneficial effects that the connecting column of the first connector and the bolt column of the second connector are clamped, such that the quick release connecting assembly is simple in integral structure and convenient to disassemble and assemble.

### BRIEF DESCRIPTION OF THE DRAWINGS

FIG. 1 is a schematic diagram of the embodiment.

FIG. 2 is a separation schematic diagram of the embodiment.

FIG. 3 is a sectional schematic diagram of the embodiment.

FIG. 4 is a schematic diagram of the second connector without the carrying ring.

FIG. 5 is another schematic diagram of the embodiment.

### MARKS OF DRAWINGS

1—first connector; 11—upper fixed plate; 12—clamping slot; 13—connecting column; 2—second connector; 21—lower fixed plate; 22—connecting pipe; 23—carrying ring; 24—side pipe; 25—bolt column; 26—operating block; 27—limiting block; 28—spring; 29—inner edgefold; 20—L-shaped notch.

### DETAILED DESCRIPTION OF THE EMBODIMENTS

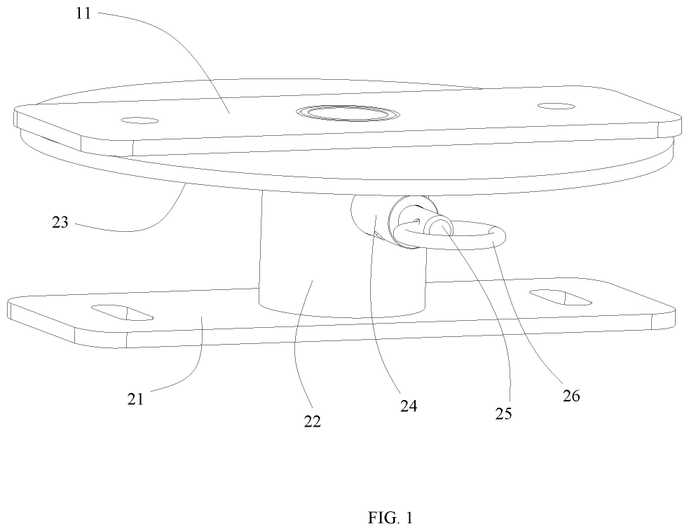

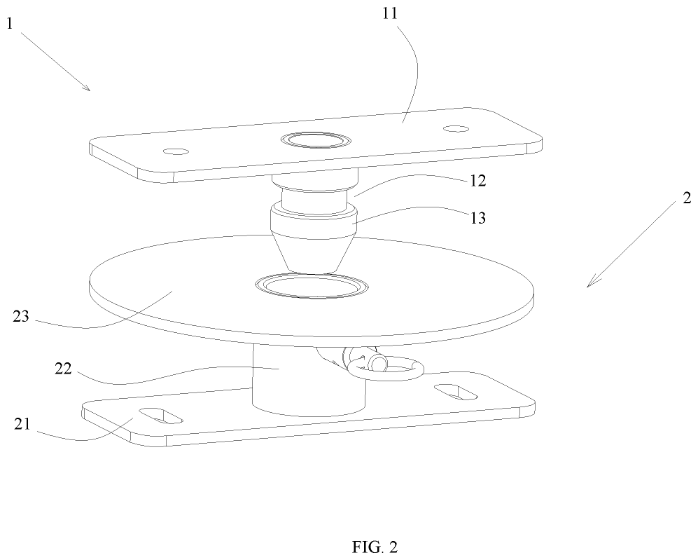

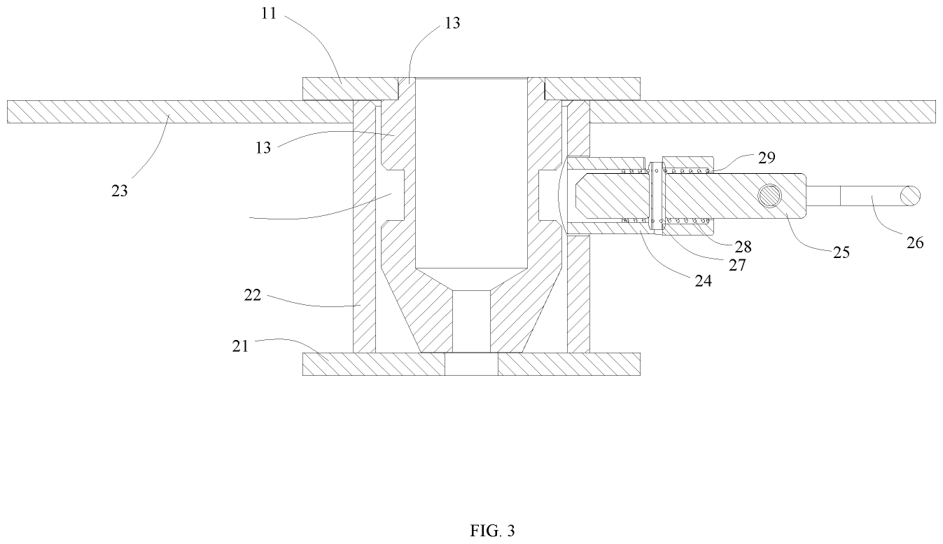

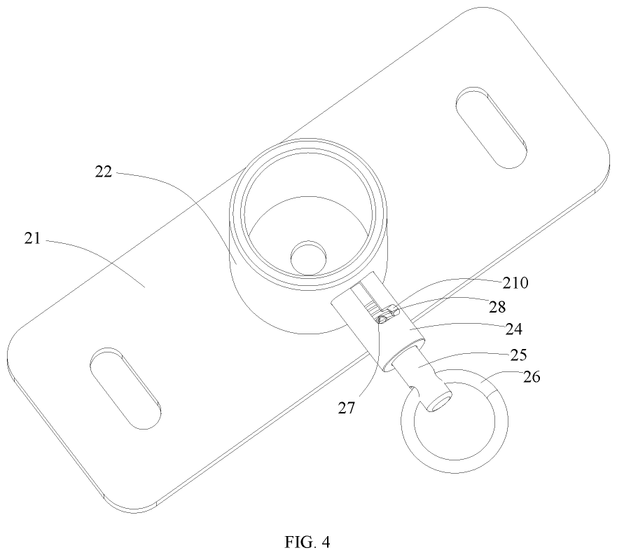

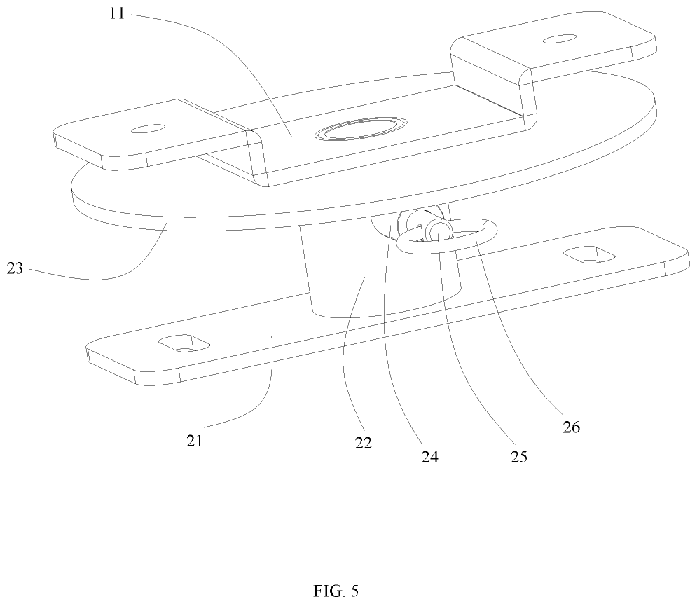

The invention is described below in details with reference to the accompanying drawings. As shown in FIG. 1 to FIG. 5,

### EXAMPLE 1

### A Quick Release Connecting Assembly Includes

a first connector 1 and a second connector 2, wherein the first connector 2 includes an upper fixed plate 11, a middle portion of the upper fixed plate 11 is connected to a connecting column 13, and a clamping slot 12 is formed in a middle portion of the connecting column 12;

and the second connector 2 includes a lower fixed plate 21, a middle portion of the lower fixed plate 21 is connected to a connecting pipe 22 matched with the connecting column 13, a side surface of the connecting pipe 22 is connected to a side pipe 24 communicating with the connecting pipe 22, and a bolt column 25 is arranged in the side pipe 24.

When the technical scheme is implemented, the first connector 1 is fixed to a bottom plate of the vehicle tent through the upper fixed plate 11, the second connector 2 is fixed to the top holder thorough the lower fixed plate 21, and during fixation, connection can be carried out by means of connectors such as bolts; during use, there may be many quick release connecting assemblies; when the vehicle tent is fixed to the top holder, the connecting column 13 of the first connector 1 is inserted into the connecting pipe 22 of the second connector 2, and then the bolt column 25 is pushed inward, such that the end portion of the bolt column 25 is inserted into the clamping slot 12; during detachment, the bolt column 25 is pulled out, the connecting column 13 of the first connector 1 is pulled out from the connecting pipe 22 of the second connector 2 and the first connector 1 and the second connector 2 are separated, such that detachment is achieved. The whole process is easy and quick to implement.

Further, an inner edgefold 29 is arranged on an outer end portion of the side pipe 24, a spring 28 for pushing the bolt column 25 inward is arranged in the side pipe 24, the spring 28 is connected outside the bolt column 25 in a sleeving manner, a side surface of the bolt column 25 is connected to a limiting block 27, and two ends of the spring 28 lean against the limiting block 27and the inner edgefold 29, separately.

After the inner edgefold 29 and the spring 28 are arranged, the bolt column 25 moving outward is subjected to resistance of the spring 28. Meanwhile, the limiting block 27 further limits the bolt column 25 to be separated from the side pipe 24.

Further, a mounting hole is formed in a side surface of the bolt column 25, and the limiting block 27 is fixed in the mounting hole.

In order to mount the limiting block 27 and detach the integral connector conveniently, according to the technical scheme, the mounting hole is formed in the side surface of the bolt column 25 and the limiting block 27 is fixed in the mounting hole; and in an actual operation, the mounting hole can be an insertion hole and the limiting block 27 can be a splicing column.

Preferably, an outer end portion of the bolt column 25 is connected to an operating block 26.

The bolt column 25 is generally cylindrical, and the outer end portion of the bolt column is hard to operate. In order to facilitate operation, the operating block 26 is arranged according to the technical scheme. In specific arrangement, a through hole is formed in the outer end portion of the bolt column 25 and a circular ring is connected through the through hole. An opening portion is arranged in a middle portion of the circular ring. During connection, the opening portion is staggered first to form an open loop, then the circular ring is inserted into the through hole and the circular ring is rotated, and when the opening portion leaves the through hole, the opening portion is reset to form a closed loop.

Further, an L-shaped notch 210 matched with the limiting block 27 is arranged on the side surface of the side pipe 24 and the L-shaped notch 210 is inserted onto the outer end portion of the limiting block 27.

When the first connector 1 and the second connector 2 are connected, the bolt column 25 needs to move outward and leave the connecting pipe 22. Before the connecting column 13 is inserted into the connecting pipe 22, the bolt column 25 needs to be kept in an away state; in order to keep the state, the L-shaped notch 210 is formed. When the bolt column leaves, the bolt column 25 is pulled outward, and the limiting block 27 moves outward along the L-shaped notch 210. When the limiting block moves to the outer end portion of the L-shaped notch 210, the bolt column 25 is then rotated, such that the bolt column 25 and the L-shaped notch 210 are clamped and movement of the bolt column 25 is limited.

Further, a lower end of the connecting column 13 is cone-shaped.

The lower end of the connecting column 13 is arranged cone-shaped, so that when the connecting column 13 enters into the connecting pipe 22, a position correcting function can be exerted, and meanwhile, the bolt column 25 can be pushed outward.

Further, an upper end of the connecting pipe 22 is connected to a carrying ring 23.

When the connecting column 13 is inserted into the connecting pipe 22, the upper fixed plate 11 has a larger pressure to the connecting pipe 22. In order to avoid local deformation of the connecting pipe 22, the carrying ring 23 is arranged at the upper end of the connecting pipe 22. The carrying ring 23 leans against the upper fixed plate 11, so that the connecting pipe 22 is prevented from deforming due to over-high local pressure. Second, when the connector is mounted, it may be hard to align the connecting column 13 with a hole position of the connecting pipe 22, and it is needed to adjust the position of the vehicle tent. At the time, the connecting column 13 can be placed on a plane of the carrying ring 23 first and then the position of the vehicle tent is adjusted and moved into the hole position of the connecting pipe 22.

The above mentioned is only the preferred embodiment of the invention. For those skilled in the art, variations will be made in specific embodiments and application range in terms of concept of the invention. The content in the description shall not be construed as limitations to the invention.

What is claimed is:

1. A quick release connecting assembly, comprising:
a first connector and a second connector, wherein
the first connector comprises an upper fixed plate, a middle portion of the upper fixed plate is connected to a connecting column, and a clamping slot is formed in a middle portion of the connecting column;
and the second connector comprises a lower fixed plate, a middle portion of the lower fixed plate is connected to a connecting pipe matched with the connecting column, a side surface of the connecting pipe is connected to a side pipe communicating with the connecting pipe, and a bolt column is arranged in the side pipe.

2. The quick release connecting assembly according to claim 1, wherein an inner edgefold is arranged on an outer end portion of the side pipe, a spring for pushing the bolt column inward is arranged in the side pipe, the spring is connected outside the bolt column in a sleeving manner, a side surface of the bolt column is connected to a limiting block, and two ends of the spring lean against the limiting block and the inner edgefold, separately.

3. The quick release connecting assembly according to claim 1, wherein a mounting hole is formed in a side surface of the bolt column, and the limiting block is fixed in the mounting hole.

4. The quick release connecting assembly according to claim 1, wherein an outer end portion of the bolt column is connected to an operating block.

5. The quick release connecting assembly according to claim 2, wherein an L-shaped notch matched with the limiting block is arranged on a side surface of the side pipe and the L-shaped notch is inserted onto an outer end portion of the limiting block.

6. The quick release connecting assembly according to claim 2, wherein a lower end of the connecting column is cone-shaped.

7. The quick release connecting assembly according to claim 1, wherein an upper end of the connecting pipe is connected to a carrying ring.

8. The quick release connecting assembly according to claim 2, wherein an outer end portion of the bolt column is connected to an operating block.

9. The quick release connecting assembly according to claim 3, wherein an outer end portion of the bolt column is connected to an operating block.

10. The quick release connecting assembly according to claim 3, wherein an L-shaped notch matched with the limiting block is arranged on a side surface of the side pipe and the L-shaped notch is inserted onto an outer end portion of the limiting block.

11. The quick release connecting assembly according to claim 3, wherein a lower end of the connecting column is cone-shaped.
